(19) United States
(12) Patent Application Publication
(10) Pub. No.: US 2016/0253425 A1
(43) Pub. Date: Sep. 1, 2016

(54) BLOOM FILTER BASED LOG DATA ANALYSIS

(71) Applicant: HEWLETT PACKARD ENTERPRISE DEVELOPMENT LP, Houston, TX (US)

(72) Inventors: Jason Jeffrey STOOPS, Sunnyvale, CA (US); Wei HUANG, Sunnyvale, CA (US)

(21) Appl. No.: 15/031,362

(22) PCT Filed: Jan. 17, 2014
(86) PCT No.: PCT/US2014/012103

§ 371 Date: Apr. 22, 2016

(51) Int. Cl. G06F 17/30

(52) U.S. Cl. CPC G06F 17/30867; G06F 17/3033

(57) ABSTRACT

According to an example, bloom filter based log data analysis may include pre-computing hash values related to log data information from log data to generate a data range based bloom filter corresponding to a data range of the log data. The pre-computed hash values may be used to generate a master bloom filter for the log data information for a predetermined amount of the log data. The predetermined amount of the log data may be greater than the data range of the log data. A hash value related to query information to be searched in the log data may be computed. The hash value may be compared to the pre-computed hash values related to the master bloom filter to determine whether the query information is likely to be present in the log data or whether the query information is not present in the log data.

### BACKGROUND

Typically, enterprise storage environments designed for large-scale, high-technology environments of modern enterprises involve the storage of large amounts of historical log data. The log data may be searched for a variety of occurrences of query information related to a search query. For example, the log data may be searched for the occurrence of a particular Internet protocol (IP) address, or a host name. The search query for the query information may include a time range associated therewith. For example, the search query may include a time range for the past ten minutes, the past six months, etc., associated therewith.

### BRIEF DESCRIPTION OF DRAWINGS

Features of the present disclosure are illustrated by way of example and not limited in the following figure(s), in which like numerals indicate like elements, in which:

FIG. 1 illustrates an architecture of a bloom filter based log data analysis apparatus, according to an example of the present disclosure;

FIG. 2 illustrates a general example of a bloom filter, according to an example of the present disclosure;

FIG. 3 illustrates a graph of bloom filter properties related to false positive probability, according to an example of the present disclosure;

FIG. 4 illustrates operation of the bloom filter based log data analysis apparatus, according to an example of the present disclosure;

FIG. 5 illustrates operation of a bloom filter specification module of the bloom filter based log data analysis apparatus for bloom filter scalability, according to an example of the present disclosure;

FIG. 6 illustrates further operations of the bloom filter specification module for bloom filter scalability, according to an example of the present disclosure;

FIG. 7 illustrates query processing against a plurality of scalable bloom filters, according to an example of the present disclosure;

FIG. 8 illustrates query processing for a particular host name against log data, according to an example of the present disclosure;

FIG. 9 illustrates a method for bloom filter based log data analysis, according to an example of the present disclosure;

FIG. 10 illustrates further details of the method for bloom filter based log data analysis, according to an example of the present disclosure; and

FIG. 11 illustrates a computer system, according to an example of the present disclosure.

### DETAILED DESCRIPTION

For simplicity and illustrative purposes, the present disclosure is described by referring mainly to examples. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure.

Throughout the present disclosure, the terms “a” and “an” are intended to denote at least one of a particular element. As used herein, the term “includes” means includes but not limited to, the term “including” means including but not limited to. The term “based on” means based at least in part on.

In environments, such as, enterprise storage environments that involve the storage of large amounts of historical log data, the log data may be searched for the occurrence of query information related to a search query, for example, by checking each log message of the log data individually. The time and resource utilization for a search may be reduced, for example, by limiting the search to a time range. However, absent further elimination of log data that needs to be searched, reduction of any further time and resource utilization related to the search may be limited.

According to examples, a bloom filter based log data analysis apparatus and a method for bloom filter based log data analysis are disclosed herein. The apparatus and method disclosed herein may provide for a search operation related to the log data to rule out data ranges of the log data that definitely do not contain the query information related to a search query through the use of bloom filters. The data ranges of the log data may be related, for example, to time-based ranges of the log data. For example, the data ranges of the log data may be based on log data from a ten minute range, a six hour range, etc., of the log data. Alternatively or additionally, the data ranges of the log data may be based on a number of log data messages associated with the log data, or other aspects that may be used to divide the log data as needed. Compared, for example, to the log data, a bloom filter may take up a relatively small amount of memory storage space. Further, a bloom filter may be checked relatively quickly to determine if the bloom filter contains a particular query information related to a search query.

The bloom filter may determine that a particular log data information (e.g., an IP address, host name, etc.) was probably added with a quantifiable false positive rate. Further, the bloom filter may determine that a particular log data information was definitely not added, without any chance of a false negative result. By accepting the occasional false positive result from the bloom filter as unneeded effort, search speeds related to searching of the log data may be increased for queries with few or no results since large ranges of the log data may be ruled out by the bloom filters. Thus, by eliminating data ranges of the log data that definitely do not include any search results related to a search query, the apparatus and method disclosed herein may limit searching to ranges of the log data that are known, with a predetermined measure of certainty, to contain relevant results related to the query information. For queries with zero results, the overall search speed may be constant, since all of the log data may be eliminated from containing search results.

The generation of the bloom filters as the log data is received may add a relatively small amount of overhead (i.e., bloom filter data) due to the typical nature of the log data being tracked. Further, the storage of the bloom filter data may be generally negligible in comparison to the storage of the log data. Therefore, with the use of the bloom filters, the apparatus and method disclosed herein may efficiently search the log data for query information.

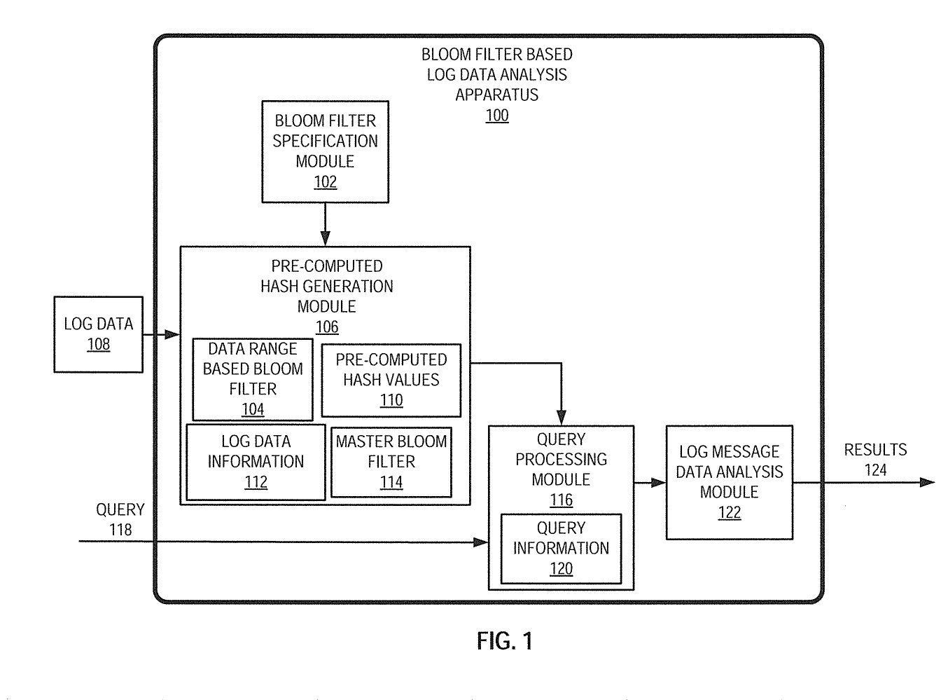

FIG. 1 illustrates an architecture of a bloom filter based log data analysis apparatus (hereinafter also referred to as “apparatus 100”), according to an example of the present disclosure. Referring to FIG. 1, the apparatus 100 is depicted as including a bloom filter specification module 102 to specify characteristics of a data range based bloom filter 104. The characteristics of the data range based bloom filter 104 may include, for example, an acceptable false positive rate (e.g., 0.01%, 0.001%, etc.). As discussed in further detail herein, the bloom filter specification module 102 may also specify characteristics for scaling a plurality of the data range based bloom filters 104.

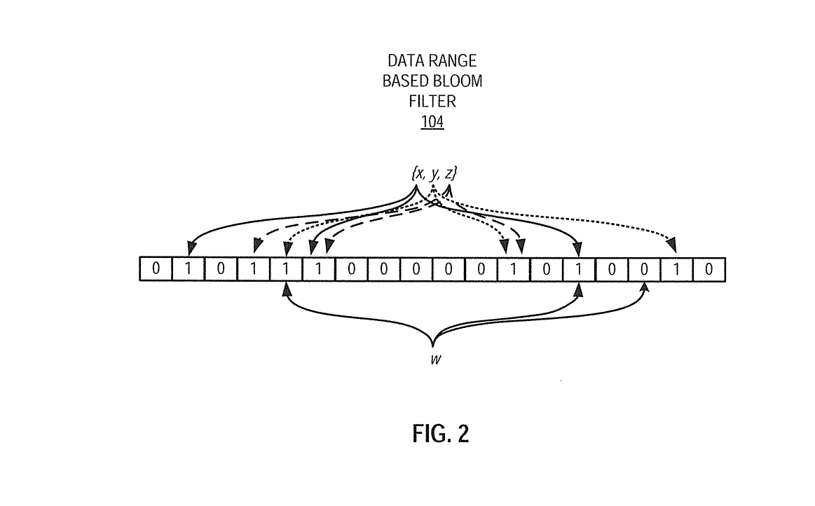

FIG. 2 illustrates a general example of a data range based bloom filter 104, according to an example of the present disclosure. The data range based bloom filter 104 of FIG. 2 may include, for example, eighteen bits, with hash values generated for values x, y, and z. In order to add a value to the bloom filter, a predetermined number (e.g., k) of hashes of the value to be added (e.g., x, y, or z) may be generated. A modulo m may be computed for each hash, and a corresponding bit may be ascertained for each hash value. The corresponding bit may be set to 1. In order to check a value (e.g., w), the predetermined number (e.g., k) of hashes of the value to be checked may be generated. Each hashed value may be evaluated to determine whether the hashed value has a corresponding bit set to 1. If the hashed value has a corresponding bit set to 1, that value may be determined to be added to a set with a predetermined measure of certainty. If the hashed value has any corresponding bit that is not set to 1 (e.g., as shown in FIG. 2 for the fifteenth bit for w), that value may be determined not to be added to a set, without any chance of a false negative result.

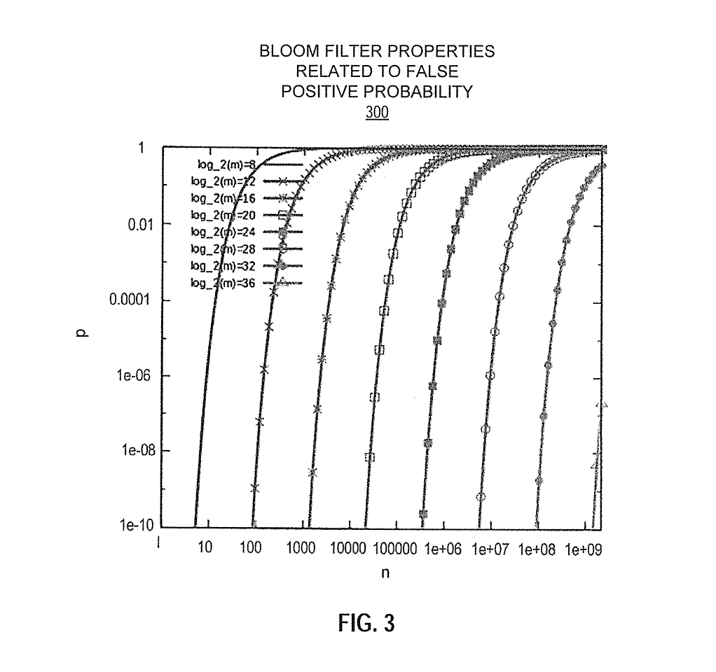

FIG. 3 illustrates a graph 300 of bloom filter properties related to false positive probability, according to an example of the present disclosure. Generally, for the data range based bloom filter 104, the number of bits of the data range based bloom filter 104 may be inversely proportional to the false positive probability. That is, adding additional bits to the data range based bloom filter 104 may lower the false positive probability. Further, reducing the number of values that are added to the data range based bloom filter 104 may lower the false positive probability. That is, if the number of values that are added to the data range based bloom filter 104 continues to increase, eventually, all checks for values against the data range based bloom filter 104 may return true (i.e., that the set represented by the bloom filter includes the value). For FIG. 3, the horizontal axis may represent the number of bits of the data range based bloom filter 104, and the vertical axis may represent the false positive probability.

Referring to FIG. 1, a pre-computed hash generation module 106 may receive log data 108, and pre-compute hash values 110 related to specific log data information 112 from the log data 108 to generate the data range based bloom filter 104. For example, the log data information 112 may include a particular IP address, host name, port number, media access control (MAC) address, etc., that may need to be searched in the log data 108. The log data information 112 may be present in column format in the log data 108. The log data 108 may be partitioned based on a number of distinct events (e.g., increments of 1000 events), based on time-based data ranges (e.g., log data for x-minutes, x-hours, x-days, etc.), or based on other aspects related to the log data 108. A different data range based bloom filter 104 may be generated for each log data information 112 (e.g., each IP address, host name, port number, MAC address, etc.), per data range of the log data information 112. Further, a master bloom filter 114 may be generated for each log data information 112 for a predetermined amount, or for all of the log data 108 for the particular log data information 112. That is, each master bloom filter 114 may encompass a predetermined amount, or all of the data range based bloom filters 104 for all of the data ranges for the particular log data information 112.

The pre-computed hash generation module 106 may ascertain information related to a longest storage group retention timeframe for a storage group including a predetermined number of the data ranges for the particular log data information 112, and generate the master bloom filter 114 based on the longest storage group retention timeframe. In this manner, the master bloom filter 114 may stay current as to a predetermined number of the data ranges for the particular log data information 112.

The pre-computed hash values 110 may be computed for each of the different data range based bloom filters 104 for each log data information 112 per data range of the log data information 112, and for the corresponding master bloom filter 114. Alternatively or additionally, the pre-computed hash values 110 computed for each of the different data range based bloom filters 104 for each log data information 112 per data range of the log data information 112 may be used to compute the pre-computed hash values 110 for the corresponding master bloom filter 114.

The pre-computed hash generation module 106 may support linear combinations of the pre-computed hash values. For example, instead of computing a hash a plurality (e.g., fifteen) times, the hash may be computed twice and combined to obtain the needed hash values for the data range based bloom filter 104 and/or the master bloom filter 114. For example, for an input x for a bloom filter of size m bits, two hash values for the input x may be computed, named h₁ and h₂. In order to derive all the needed k bloom filter hash values b₁, b₂, b₃ . . . bₖ, b₁=(h₁+(i*h₂)) mod m may be computed.

Referring to FIG. 1, a query processing module 116 may receive a query 118 that includes query information 120 that may be related to the log data information 112, and evaluate the pre-computed hash values 110 related to the log data information 112 to determine whether the query information 120 is likely to be (i.e., probably) present in the log data 108 with a quantifiable false positive rate (e.g., 0.01%, 0.001%, etc., as specified by the bloom filter specification module 102). For example, for a 0.01% false positive rate, the query processing module 116 may evaluate the pre-computed hash values 110 related to the log data information 112 to determine whether the query information 120 is likely to be present in the log data 108, with there being a 0.01% probability as specified by the false positive rate that the determination by the query processing module 116 is incorrect, and thus a 99.99% probability that the determination by the query processing module 116 is correct. Thus, the determination of whether the query information 120 is likely to be present in the log data 108 may include an indication of a probability y of whether the determination by the query processing module 116 is incorrect based on the specified false positive rate, and a probability 1−y of whether the determination by the query processing module 116 is correct based on the specified false positive rate. The aspect of “likely to be present” may thus account for the possibility that the query information 120 may not actually be present in the log data 108, despite a determination by the query processing module 116 that the query information 120 is present in the log data 108. Therefore, for a specified false positive rate (e.g., z), a determination of the likelihood of presence (i.e., likely to be present) being correct for the query information 120 in the log data 108 may be specified as 1−z. Further, the query processing module 116 may evaluate the pre-computed hash values 110 related to the log data information 112 to determine whether the query information 120 is definitely not present in the log data 108, without any chance of a false negative result. The query 118 may further specify a query data range that may fall within the data range of a given data range based bloom filter 104, or may otherwise overlap the data ranges for a plurality of the data range based bloom filters 104.

The query processing module 116 may first evaluate the pre-computed hash values 110 related to the log data information 112 for the master bloom filter 114. If the pre-computed hash values 110 related to the log data information 112 for the master bloom filter 114 indicate that the log data information 112 has not been received (i.e., the query information 120 is not present in the log data 108), the query processing module 116 may perform no further analysis of the pre-computed hash values 110, and report the results to a log message data analysis module 122.

If the pre-computed hash values 110 related to the log data information 112 for the master bloom filter 114 indicate that the log data information 112 may likely have been received (i.e., the query information 120 may likely be present in the log data 108), the query processing module 116 may further evaluate the pre-computed hash values 110 related to the log data information 112 for each of the different data range based bloom filters 104 for the specific data range specified in the query 118.

If the pre-computed hash values 110 related to the log data information 112 for all of the different data range based bloom filters 104 for the specific data range specified in the query 118 indicate that the log data information 112 has not been received (i.e., the query information 120 is not present in the log data 108 for the data ranges corresponding to the different data range based bloom filters 104), the query processing module 116 may report the results to the log message data analysis module 122.

Further, if the pre-computed hash values 110 related to the log data information 112 for any of the different data range based bloom filters 104 for the specific data range specified in the query 118 indicate that the log data information 112 may likely have been received (i.e., the query information 120 may likely be present in the log data 108 for the data ranges corresponding to the different data range based bloom filters 104), the query processing module 116 may report the results to the log message data analysis module 122.

The log message data analysis module 122 may further evaluate the log data 108 based on the determination by the query processing module 116. For example, based on the determination by the query processing module 116 that the query information 120 is likely to be present in the log data 108, the log message data analysis module 122 may further evaluate the log data 108 to confirm presence of the query information 120. For example, the log message data analysis module 122 may further evaluate the specific data ranges of the log data 108 where the query processing module 116 indicates presence of the query information 120 to confirm presence of the query information 120. For any data ranges of the log data 108 that are determined by the query processing module 116 to definitely not include the query information 120, these data ranges may be eliminated by the log message data analysis module 122 from further evaluation. Similarly, if the master bloom filter 114 is determined not to include the query information 120 by the query processing module 116, the log message data analysis module 122 may report results 124 of the analysis to a user of the bloom filter based log data analysis apparatus 100, without further analysis of any of the log data 108.

The modules and other elements of the apparatus 100 may be machine readable instructions stored on a non-transitory computer readable medium. In addition, or alternatively, the modules and other elements of the apparatus 100 may be hardware or a combination of machine readable instructions and hardware.

The data range based bloom filter 104 and/or the master bloom filter 114 may report false positives with a predictable probability as discussed above with reference to FIG. 3. Based on the predictable probability, at times, the log data 108 may be searched by the log message data analysis module 122 for the query information 120 when the log data 108 does not contain the particular query information 120. However, when there are 0 or few results 124 related to the query information 120, the overall search time from receipt of the query 118 to generation of the results 124 may be comparably reduced based on evaluation of the master bloom filter 114 and elimination of all of the log data 108 for the query information 120, or based on evaluation of the data range based bloom filters 104 and elimination of certain data ranges of the log data 108 for the query information 120.

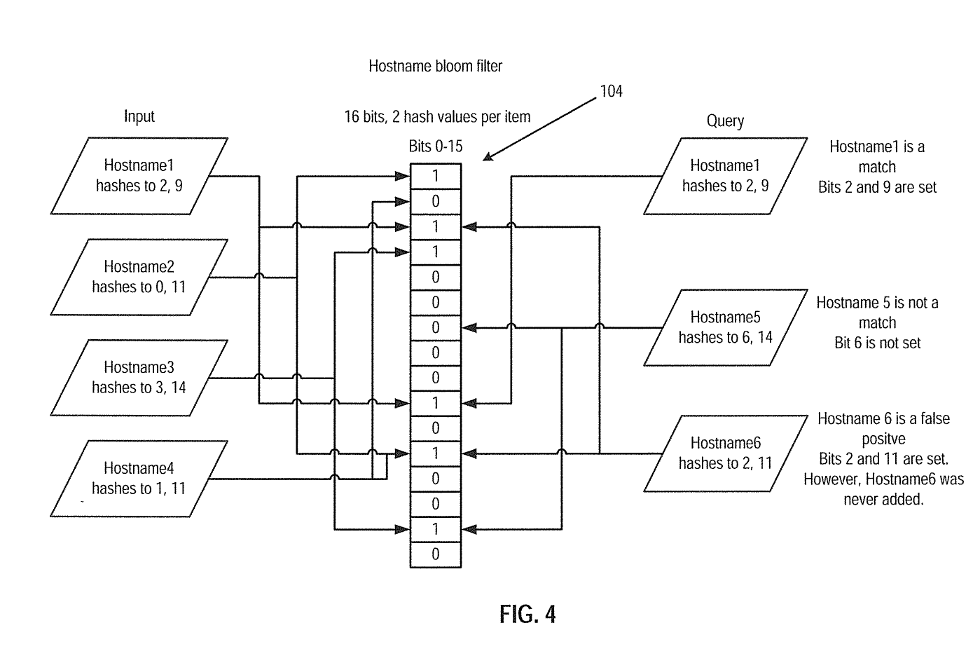

FIG. 4 illustrates operation of the bloom filter based log data analysis apparatus 100, according to an example of the present disclosure. For the example of FIG. 4, the bloom filter specification module 102 may specify characteristics of the data range based bloom filter 104 to include 16 bits, with 2 hash values per item. The pre-computed hash generation module 106 may receive the log data 108, and pre-compute hash values 110 related to specific log data information 112 from the log data 108 to generate the data range based bloom filter 104. For the example of FIG. 4, the log data information 112 may include hostnames, such as, hostname1, hostname2, hostname3, and hostname4. For the example of FIG. 4, hostname1 may hash to 2,9, hostname 2 may hash to 0, 11, etc. The query processing module 116 may receive the query 118 related to the query information 120 (e.g., hostnames), and evaluate the pre-computed hash values 110 related to log data information 112 to determine whether the query information 120 is likely to be present in the log data 108 with a quantifiable false positive rate. For example, the query 118 may be related to hostname1, hostname5, and hostname 6. As shown in FIG. 4, hostname1 may match to bits 2,9 that are set, thus yielding a result 124 indicating that hostname1 is likely to be present in the log data 108 with a quantifiable false positive rate. Hostname5 may match to bits 6,14, where bit 6 is not set, thus yielding a result 124 indicating that hostname5 is definitely not present in the log data 108, without any chance of a false negative result. Hostname6 may match to bits 2,11 that are set, thus yielding a result 124 indicating that hostname6 is likely to be present in the log data 108 with a quantifiable false positive rate. However, since hostname6 was never added, it can be seen that hostname6 results in a false positive indication that hostname6 is likely to be present in the log data 108.

The pre-computed hash values 110 for the data range based bloom filters 104 related to the specified data range may be stored adjacent to the log data 108 for the particular data range. This may provide for the application of the same archiving, retention, and storage limits and/or policies to the pre-computed hash values 110 and the log data 108. For example, when the log data 108 falls outside a retention period, the log data 108 and associated pre-computed hash values 110 may be deleted, for example, to avoid unneeded storage of the pre-computed hash values 110. The pre-computed hash values 110 for the master bloom filter 114 may be stored separately from the log data 108. This may provide for application of storage group limits to the pre-computed hash values 110 for the master bloom filter 114.

The data range based bloom filters 104 may also track a number of log messages (or other distinct values) for the log data 108 that are contained in the data ranges associated with the data range based bloom filters 104. The tracked number of log messages may be used to determine a number of the log messages or other events scanned by the query processing module 116 and/or the log message data analysis module 122. Further, the number of log messages that are eliminated by the data range based bloom filters 104 and/or the master bloom filter 114 may also be added to the number of log messages that are actually scanned by the query processing module 116 and/or the log message data analysis module 122 to determine a total amount of the log messages or other events that are subject to the query 118. The total amount of the log messages or other events that are subject to the query 118 may be used to confirm whether all of the appropriate log data 108 has been evaluated. For example, in the event of an error in the evaluation of the log data 108, for example, due to an unexpected event, the number of log messages for a given data range of the log data 108 may be compared to the total number of the log data 108 that has been evaluated by the query processing module 116 and/or the log message data analysis module 122 to confirm that all of the log data in the given data range has been evaluated (i.e., some of the log data 108 has not been inadvertently omitted from evaluation).

The bloom filter specification module 102 may also specify characteristics for scaling a plurality of the data range based bloom filters 104. For such scaled data range based bloom filters 104, the pre-computed hash generation module 106 may generate corresponding pre-computed hash values 110 that are also scaled. The scaled pre-computed hash values 110 may be used by the query processing module 116 in a similar manner as the pre-computed hash values 110 that do not include scaling, except that the scaled pre-computed hash values 110 may be used to evaluate corresponding scaled data range based bloom filters 104 (i.e., data range based bloom filters 104 with similar parameters, such as, bits, as the scaled pre-computed hash values 110).

With respect to scaling of a plurality of the data range based bloom filters 104, the when a bloom filter reaches a specified number of elements (e.g., 1000 elements), a further bloom filter that holds, for example, twice, or another predetermined number of elements, may be added. Similarly, further bloom filters may be added as needed once existing bloom filters reach a specified number of elements.

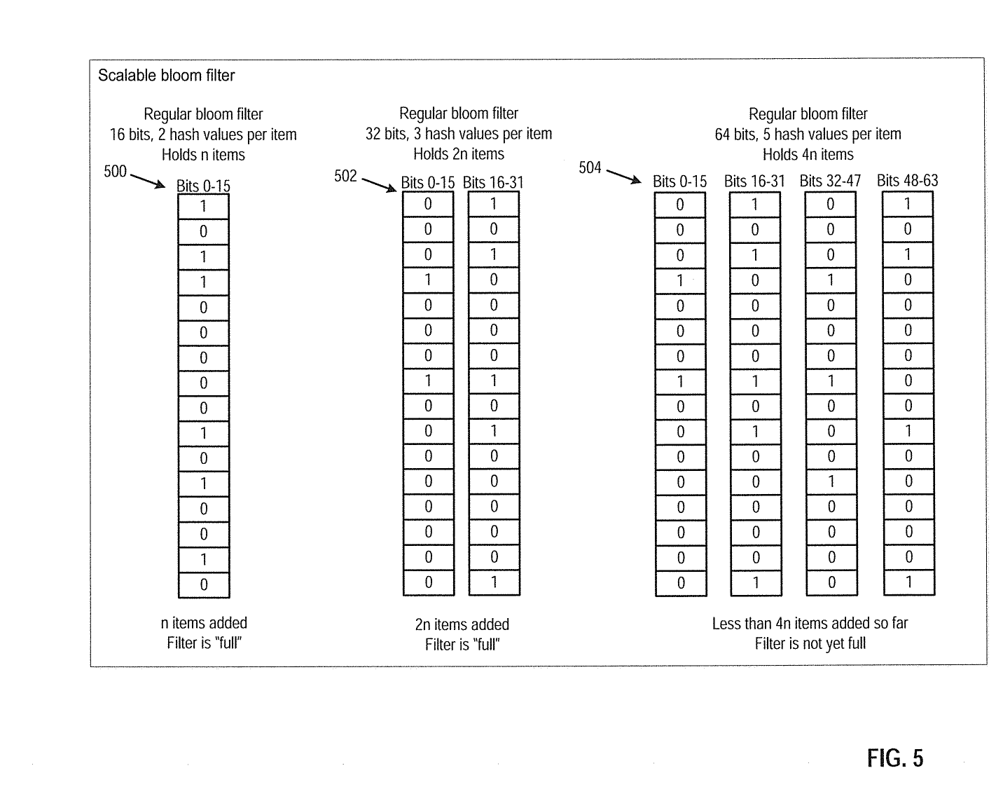

FIG. 5 illustrates operation of the bloom filter specification module 102 for bloom filter scalability, according to an example of the present disclosure. As shown in FIG. 5, the bloom filter 500 may include 16 bits, with 2 hash values per item (i.e., specific log data information 112), and hold n items. Once the current bloom filter 500 fills up, a new bloom filter 502 may be added that can handle twice the number of elements as the previous bloom filter 500. Further, once the current bloom filter 502 fills up, a new bloom filter 504 may be added that can handle twice the number of elements as the previous bloom filter 502. New elements may be added to the largest bloom filter available (e.g., bloom filter 504 if all three bloom filters 500, 502, and 504 are being used).

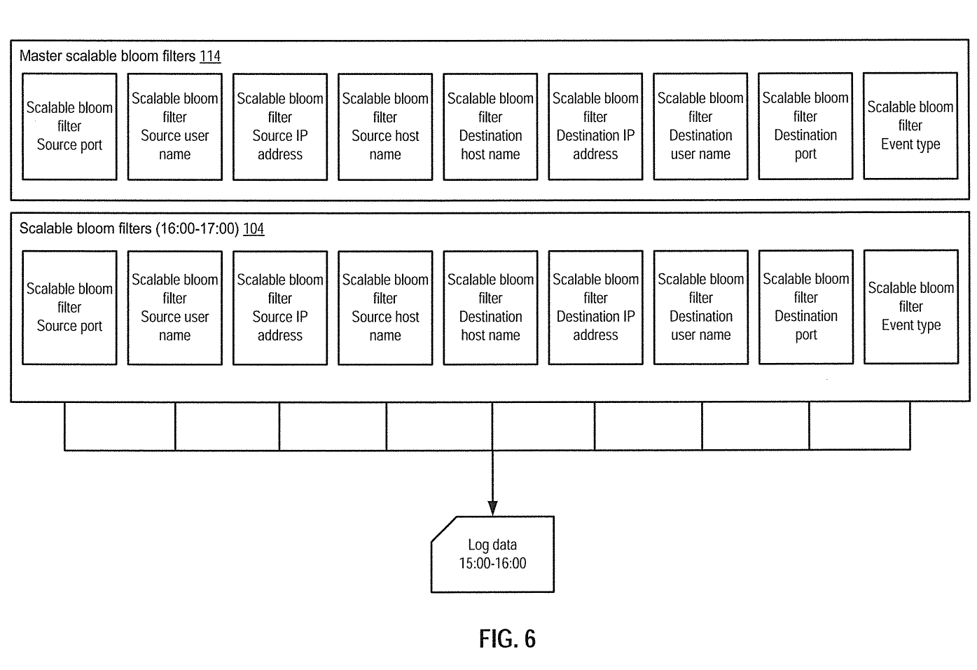

FIG. 6 illustrates further operations of the bloom filter specification module 102 for bloom filter scalability, according to an example of the present disclosure. As shown in FIG. 6, the bloom filter based log data analysis apparatus 100 may include a two tier bloom filter structure. The first tier may include the master bloom filters 114 for the log data information 112 for the entire log data 108. For the example of FIG. 6, the master bloom filters 114 may include master bloom filters for the log data information 112 including source port, source user name, source IP address, etc. The second tier may include the data range based bloom filters 104 for the log data information 112 per data range (e.g., data range 16:00-17:00 hrs.) for a particular day. Additional tiers may include the data range based bloom filters 104 for the log data information 112 per data range (e.g., data range 15:00-16:00 hrs.) for a particular day, and so forth.

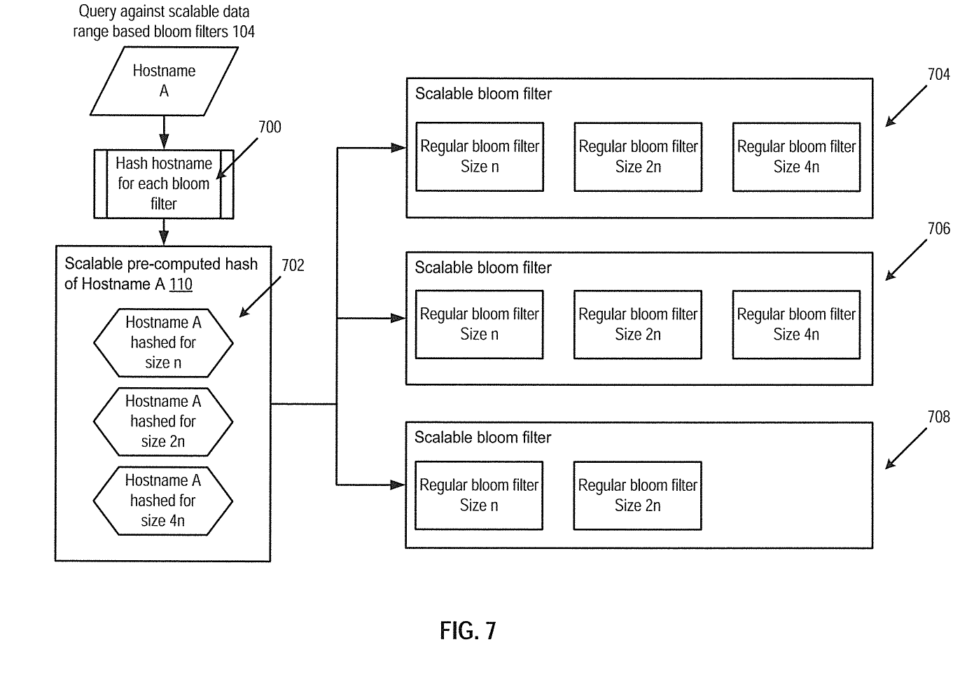

FIG. 7 illustrates query processing against a plurality of scalable data range based bloom filters 104, according to an example of the present disclosure. As discussed herein, for scalable data range based bloom filters 104, the scaled pre-computed hash values 110 may be used by the query processing module 116 in a similar manner as the pre-computed hash values 110 that do not include scaling, except that the scaled pre-computed hash values 110 may be used to evaluate corresponding scaled data range based bloom filters 104 (i.e., data range based bloom filters 104 with similar parameters, such as, bits, as the scaled pre-computed hash values 110). For example, as shown in FIG. 7, for the query information 120 related to hostnameA, for a query against a plurality of scalable data range based bloom filters 104, the pre-computed hash generation module 106 may compute the scalable pre-computed hash values 110. For example, at 700, the hostnameA may be hashed for each bloom filter. At 702, the scalable pre-computed hash values 110 for hostnameA for a bloom filter of size n, for a bloom filter of size 2n, and for a bloom filter of size 4n, are illustrated. As shown at 704, 706, and 708, the scalable data range based bloom filters 104 may be of different sizes, with the size depending on the number of elements that have been added to the bloom filter. If a scalable bloom filter is encountered and needs a larger pre-computed hash, the new hash may be generated and stored for the rest of the query. In this manner, the larger hash may be reused against other bloom filters of a similar size. Further, the scalable bloom filters may be constructed with the same number of bits and hashes to allow for reuse of hashed values at query time.

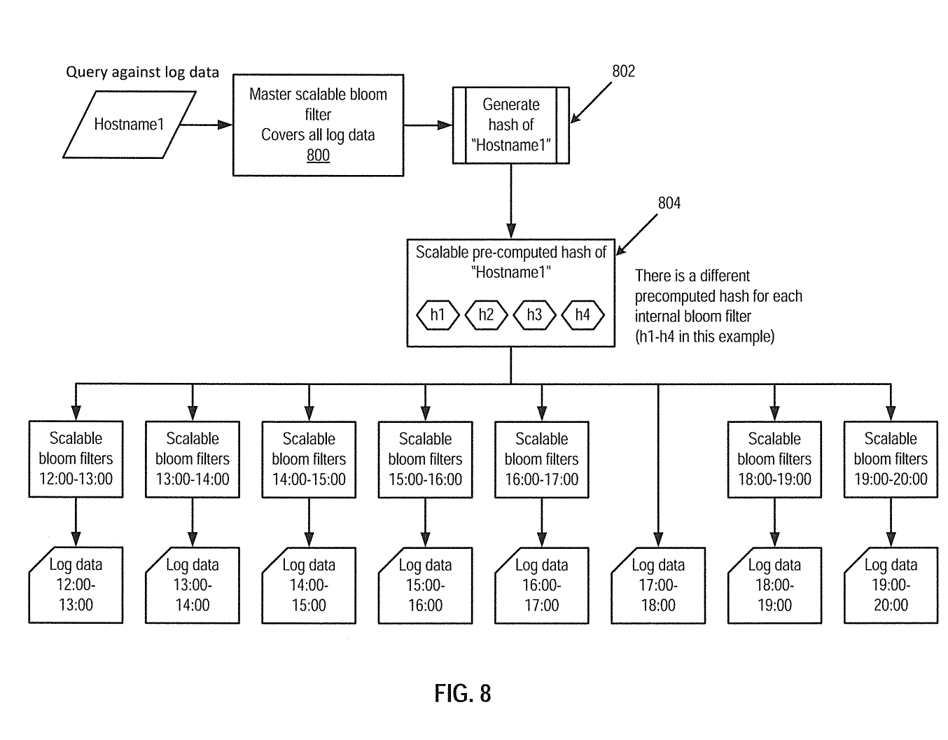

FIG. 8 illustrates query processing for a particular host name against a the log data 108, according to an example of the present disclosure. At 800, when querying, for example, for hostname1, initially the master bloom filter 114 may be checked to determine if the query information 120 (i.e., hostname1) has ever been seen. If the master bloom filter indicates that the query information 120 has likely been seen, at 802, a hash may be generated for hostname1. At 804, a pre-computed hash of the query term hostname1 may be generated to check against all the different data ranges. If a scalable bloom filter reports a hit, the corresponding data may be checked. If no bloom filters are present, the log data 108 may also be checked. In the example of FIG. 8, there are hits in the ranges 13:00-14:00 and 15:00-16:00. The log data for 17:00-18:00 has no hits but may not be ruled out because bloom filter data is not present. The bloom filter for the range 19:00-20:00 reported a false positive result, and thus, the related log data 108 may be checked, but no search result is found.

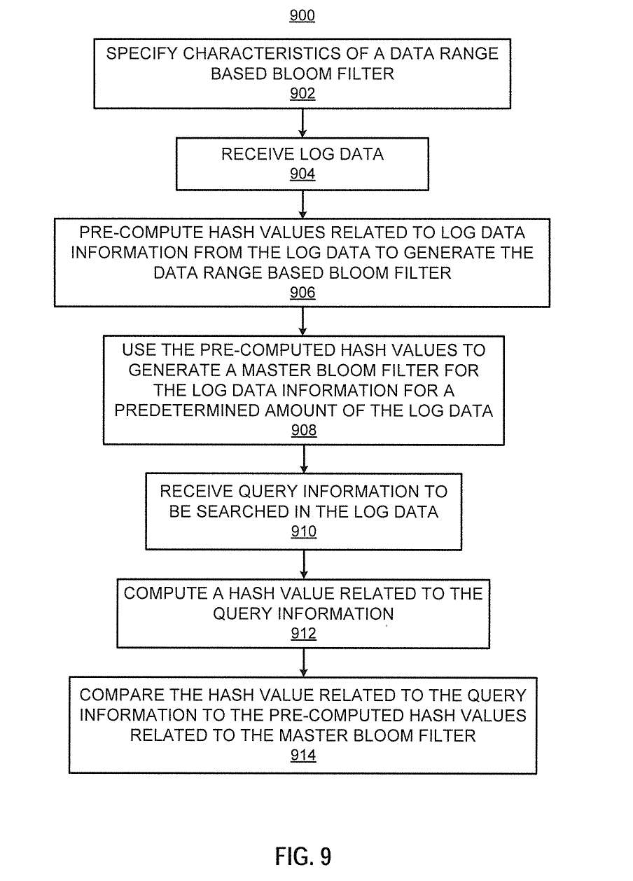

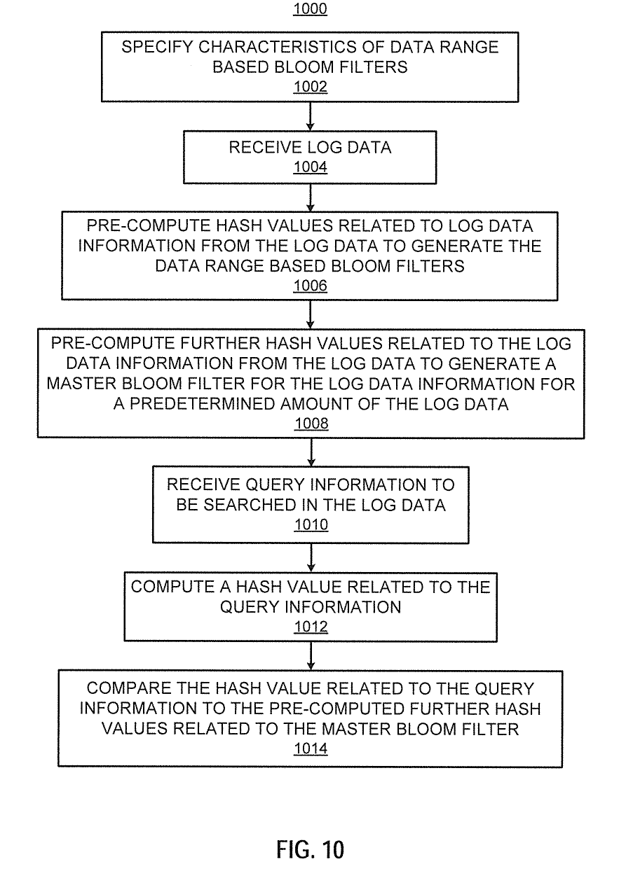

FIGS. 9 and 10 respectively illustrate flowcharts of methods 900 and 1000 for bloom filter based log data analysis, corresponding to the example of the bloom filter based log data analysis apparatus 100 whose construction is described in detail above. The methods 900 and 1000 may be implemented on the bloom filter based log data analysis apparatus 100 with reference to FIGS. 1-8 by way of example and not limitation. The methods 900 and 1000 may be practiced in other apparatus.

Referring to FIG. 9, for the method 900, at block 902, the method may include specifying characteristics of a data range based bloom filter 104. According to an example, the method may include specifying an acceptable false positive rate that is related to whether the query information 120 is likely to be present in the log data 108. According to an example, the method may include specifying the characteristics for scaling a plurality of data range based bloom filters that include the data range based bloom filter. According to an example, the data range of the log data 108 may be a time-based data range that includes a number of log messages of the log data for a predetermined amount of time

At block 904, the method may include receiving log data 108.

At block 906, the method may include pre-computing hash values 110 related to log data information 112 from the log data 108 to generate the data range based bloom filter 104 based on the specified characteristics. According to an example, the data range based bloom filter 104 may correspond to a data range of the log data 108. According to an example, the method may include pre-computing the hash values related to the log data information 112 from the log data 108 to generate a plurality of data range based bloom filters that include the data range based bloom filter based on the specified characteristics. According to an example, the plurality of data range based bloom filters may correspond to a plurality of data ranges that include the data range of the log data 108.

At block 908, the method may include using the pre-computed hash values 110 to generate a master bloom filter 114 for the log data information 112 for a predetermined amount of the log data 108. According to an example, the predetermined amount of the log data 108 may be greater than the data range of the log data 108.

At block 910, the method may include receiving query information 120 to be searched in the log data 108.

At block 912, the method may include computing a hash value related to the query information 120.

At block 914, the method may include comparing the hash value related to the query information 120 to the pre-computed hash values 110 related to the master bloom filter 114 to determine whether the query information 120 is likely to be present in the log data 108 or whether the query information 120 is not present in the log data 108. According to an example, in response to a determination that the query information 120 is likely to be present in the log data 108, the method may include comparing the hash value related to the query information 120 to the pre-computed hash values 110 related to the data range based bloom filter 104 to determine whether the query information 120 is likely to be present in the data range of the log data 108 or whether the query information 120 is not present in the data range of the log data 108. According to an example, in response to a determination that the query information 120 is not present in the log data 108, the method may include stopping further evaluation of the log data 108. According to an example, in response to a determination that the query information 120 is not present in the data range of the log data 108, the method may include stopping further evaluation of the data range of the log data 108. According to an example, in response to a determination that the query information 120 is likely to be present in the data range of the log data 108, the method may include evaluating the log data 108 to confirm presence of the query information 120 in the log data 108.

Referring to FIG. 10, for the method 1000, at block 1002, the method may include specifying characteristics of data range based bloom filters (e.g., a plurality of the data range based bloom filters 104).

At block 1004, the method may include receiving log data 108.

At block 1006, the method may include pre-computing hash values 110 related to log data information 112 from the log data 108 to generate the data range based bloom filters based on the specified characteristics. According to an example, the data range based bloom filters may correspond to a plurality of data ranges of the log data 108.

At block 1008, the method may include pre-computing further hash values (e.g., further hash values 110) related to the log data information 112 from the log data 108 to generate a master bloom filter 114 for the log data information 112 for a predetermined amount of the log data 108. The predetermined amount of the log data 108 may be greater than a total of the plurality of data ranges of the log data 108.

At block 1010, the method may include receiving query information 120 to be searched in the log data 108.

At block 1012, the method may include computing a hash value related to the query information 120.

At block 1014, the method may include comparing the hash value related to the query information 120 to the pre-computed further hash values 110 related to the master bloom filter 114 to determine whether the query information 120 is likely to be present in the log data 108 or whether the query information 120 is not present in the log data 108. According to an example, in response to a determination that the query information 120 is likely to be present in the log data 108, the method may include comparing the hash value related to the query information 120 to pre-computed hash values 110 related to an appropriate additional data range based bloom filter of the additional data range based bloom filters to determine whether the query information 120 is likely to be present in the data range of the log data 108 corresponding to the appropriate additional data range based bloom filter or whether the query information 210 is not present in the data range of the log data 108 corresponding to the appropriate additional data range based bloom filter.

According to an example, the method may include scaling the data range based bloom filters 104 by adding additional data range based bloom filters once existing data range based bloom filters are filled to a predetermined capacity related to the specified characteristics.

According to an example, the method may include specifying characteristics of a data range based bloom filter 104. The characteristics may include a size of the data range based bloom filter 104 and an acceptable false positive rate associated with the data range based bloom filter 104. The method may include receiving data (e.g., the log data 108, or other data), and pre-computing hash values related to data information (e.g., the log data information 112, or other data information) from the data to generate the data range based bloom filter 104 based on the specified characteristics. The data range based bloom filter 104 may correspond to a data range of the data. The method may include receiving query information 120 to be searched in the data, computing a hash value related to the query information 120, and comparing the hash value related to the query information 120 to the pre-computed hash values related to the data range based bloom filter 104 to determine whether the query information 120 is likely to be present in the data or whether the query information 120 is not present in the data. According to an example, a time for the comparison may be independent of a number of elements in the data range for the data that are to be searched for the query information 120.

According to an example, the method may include evaluating the data to confirm presence of the query information 120 in the data.

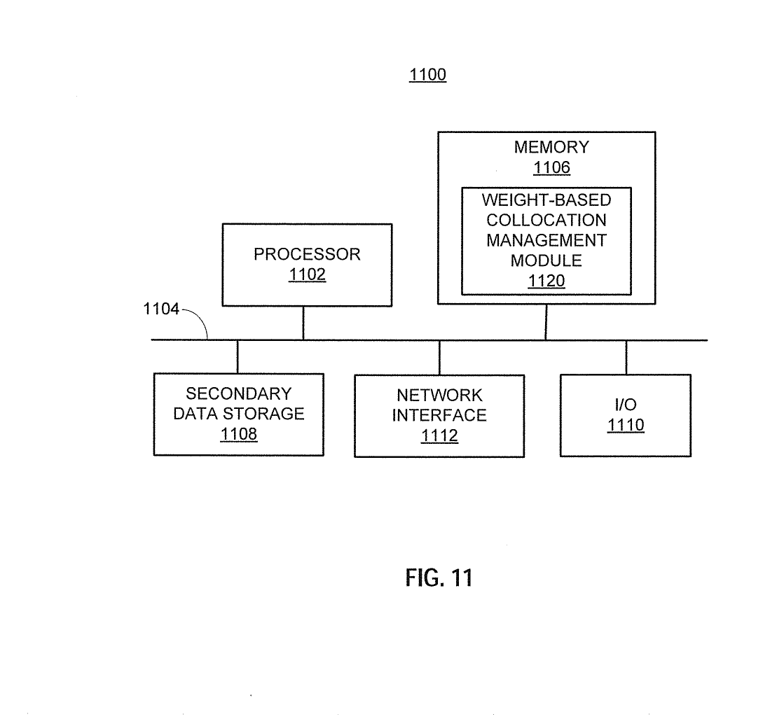

FIG. 11 shows a computer system 1100 that may be used with the examples described herein. The computer system may represent a generic platform that includes components that may be in a server or another computer system. The computer system 1100 may be used as a platform for the apparatus 100. The computer system 1100 may execute, by a processor (e.g., a single or multiple processors) or other hardware processing circuit, the methods, functions and other processes described herein. These methods, functions and other processes may be embodied as machine readable instructions stored on a computer readable medium, which may be non-transitory, such as hardware storage devices (e.g., RAM (random access memory), ROM (read only memory), EPROM (erasable, programmable ROM), EEPROM (electrically erasable, programmable ROM), hard drives, and flash memory).

The computer system 1100 may include a processor 1102 that may implement or execute machine readable instructions performing some or all of the methods, functions and other processes described herein. Commands and data from the processor 1102 may be communicated over a communication bus 1104. The computer system may also include a main memory 1106, such as a random access memory (RAM), where the machine readable instructions and data for the processor 1102 may reside during runtime, and a secondary data storage 1108, which may be non-volatile and stores machine readable instructions and data. The memory and data storage are examples of computer readable mediums. The memory 1106 may include a bloom filter based log data analysis module 1120 including machine readable instructions residing in the memory 1106 during runtime and executed by the processor 1102. The bloom filter based log data analysis module 1120 may include the modules of the apparatus 100 shown in FIG. 1.

The computer system 1100 may include an I/O device 1110, such as a keyboard, a mouse, a display, etc. The computer system may include a network interface 1112 for connecting to a network. Other known electronic components may be added or substituted in the computer system.

What has been described and illustrated herein is an example along with some of its variations. The terms, descriptions and figures used herein are set forth by way of illustration only and are not meant as limitations. Many variations are possible within the spirit and scope of the subject matter, which is intended to be defined by the following claims—and their equivalents—in which all terms are meant in their broadest reasonable sense unless otherwise indicated.

What is claimed is:

1. A non-transitory computer readable medium having stored thereon machine readable instructions to provide bloom filter based log data analysis, the machine readable instructions, when executed, cause at least one processor to:
specify characteristics of a data range based bloom filter;
receive log data;
pre-compute hash values related to log data information from the log data to generate the data range based bloom filter based on the specified characteristics, to wherein the data range based bloom filter corresponds to a data range of the log data;
use the pre-computed hash values to generate a master bloom filter for the log data information for a predetermined amount of the log data, wherein the predetermined amount of the log data is greater than the data range of the log data;
receive query information to be searched in the log data;
compute a hash value related to the query information; and
compare the hash value related to the query information to the pre-computed hash values related to the master bloom filter to determine whether the query information is likely to be present in the log data or whether the query information is not present in the log data.

2. The non-transitory computer readable medium of claim 1, wherein to compare the hash value related to the query information to the pre-computed hash values related to the master bloom filter to determine whether the query information is likely to be present in the log data or whether the query information is not present in the log data, the machine readable instructions, when executed, further cause the at least one processor to:
in response to a determination that the query information is likely to be present in the log data, compare the hash value related to the query information to the pre-computed hash values related to the data range based bloom filter to determine whether the query information is likely to be present in the data range of the log data or whether the query information is not present in the data range of the log data;
in response to a determination that the query information is not present in the log data, stop further evaluation of the log data; and
in response to a determination that the query information is not present in the data range of the log data, stop further evaluation of the data range of the log data.

3. The non-transitory computer readable medium of claim 2, wherein to compare the hash value related to the query information to the pre-computed hash values related to the data range based bloom filter to determine whether the query information is likely to be present in the data range of the log data or whether the query information is not present in the data range of the log data, the machine readable instructions, when executed, further cause the at least one processor to:
in response to a determination that the query information is likely to be present in the data range of the log data, evaluate the log data to confirm presence of the query information in the log data.

4. The non-transitory computer readable medium of claim 1, wherein to pre-compute hash values related to log data information from the log data to generate the data range based bloom filter based on the specified characteristics, the machine readable instructions, when executed, further cause the at least one processor to:
pre-compute the hash values related to the log data information from the log data to generate a plurality of data range based bloom filters that include the data range based bloom filter based on the specified characteristics, wherein the plurality of data range based bloom filters correspond to a plurality of data ranges that include the data range of the log data.

5. The non-transitory computer readable medium of claim 1, wherein to specify characteristics of a data range based bloom filter, the machine readable instructions, when executed, further cause the at least one processor to:
specify an acceptable false positive rate that is related to whether the query information is likely to be present in the log data.

6. The non-transitory computer readable medium of claim 1, wherein to specify characteristics of a data range based bloom filter, the machine readable instructions, when executed, further cause the at least one processor to:
specify the characteristics for scaling a plurality of data range based bloom filters that include the data range based bloom filter.

7. The non-transitory computer readable medium of claim 1, wherein the log data information includes one of an Internet protocol (IP) address, a host name, a port number, and a media access control (MAC) address.

8. The non-transitory computer readable medium of claim 1, wherein the log data information is organized in column format in the log data.

9. The non-transitory computer readable medium of claim 1, wherein the data range of the log data is a time-based data range that includes a number of log messages of the log data for a predetermined amount of time.

10. A bloom filter based log data analysis apparatus comprising:
at least one processor; and
a memory storing machine readable instructions that when executed by the at least one processor cause the at least one processor to:
specify characteristics of data range based bloom filters;
receive log data;
pre-compute hash values related to log data information from the log data to generate the data range based bloom filters based on the specified characteristics, wherein the data range based bloom filters correspond to a plurality of data ranges of the log data;
pre-compute further hash values related to the log data information from the log data to generate a master bloom filter for the log data information for a predetermined amount of the log data, wherein the predetermined amount of the log data is greater than a total of the plurality of data ranges of the log data;
receive query information to be searched in the log data;
compute a hash value related to the query information; and
compare the hash value related to the query information to the pre-computed further hash values related to the master bloom filter to determine whether the query information is likely to be present in the log data or whether the query information is not present in the log data.

11. The bloom filter based log data analysis apparatus according to claim 10, further comprising the machine readable instructions that when executed by the at least one processor cause the at least one processor to:
scale the data range based bloom filters by adding additional data range based bloom filters once existing data range based bloom filters are filled to a predetermined capacity related to the specified characteristics.

12. The bloom filter based log data analysis apparatus according to claim 11, wherein to compare the hash value related to the query information to the pre-computed further hash values related to the master bloom filter to determine whether the query information is likely to be present in the log data or whether the query information is not present in the log data, the machine readable instructions, when executed, further cause the at least one processor to:
in response to a determination that the query information is likely to be present in the log data, compare the hash value related to the query information to pre-computed hash values related to an appropriate additional data range based bloom filter of the additional data range based bloom filters to determine whether the query information is likely to be present in the data range of the log data corresponding to the appropriate additional data range based bloom filter or whether the query information is not present in the data range of the log data corresponding to the appropriate additional data range based bloom filter.

13. A method for bloom filter based data analysis, the method comprising:
specifying characteristics of a data range based bloom filter, wherein the characteristics include a size of the data range based bloom filter and an acceptable false positive rate associated with the data range based bloom filter;
receiving data;
pre-computing hash values related to data information from the data to generate the data range based bloom filter based on the specified characteristics, wherein the data range based bloom filter corresponds to a data range of the data;
receiving query information to be searched in the data;
computing a hash value related to the query information; and
comparing, by at least one processor, the hash value related to the query information to the pre-computed hash values related to the data range based bloom filter to determine whether the query information is likely to be present in the data or whether the query information is not present in the data.

14. The method of claim 13, wherein a time for the comparison is independent of a number of elements in the data range for the data that are to be searched for the query information.

15. The method of claim 13, wherein in response to a determination that the query information is likely to be present in the data, the method further comprises:
evaluating the data to confirm presence of the query information in the data.
